(19) United States
(12) Patent Application Publication
(10) Pub. No.: US 2020/0350557 A1
(43) Pub. Date: Nov. 5, 2020

(54) NEGATIVE ELECTRODE FOR RECHARGEABLE LITHIUM BATTERY AND RECHARGEABLE LITHIUM BATTERY COMPRISING THE SAME

(71) Applicant: Samsung SDI Co., Ltd., Yongin-si (KR)

(72) Inventors: Jaehwan Ha, Yongin-si (KR); Kijun Kim, Yongin-si (KR); Beom Kwon Kim, Yongin-si (KR); Junghyun Nam, Yongin-si (KR); Heeeun Yoo, Yongin-si (KR); Yeonhee Yoon, Yongin-si (KR); Kyuseo Lee, Yongin-si (KR); Dongmyung Lee, Yongin-si (KR)

(21) Appl. No.: 16/864,294

(22) Filed: May 1, 2020

(30) Foreign Application Priority Data
May 3, 2019 (KR) 10-2019-0052569

(51) Int. Cl. H01M 4/133; H01M 10/0525; H01M 4/62; H01M 4/525; H01M 4/505

(52) U.S. Cl. CPC H01M 4/133; H01M 10/0525; H01M 2004/027; H01M 4/525; H01M 4/505; H01M 4/621

(57) ABSTRACT

A negative electrode for a rechargeable lithium battery, includes: a sequential laminate having a negative current collector, a negative active material layer, and a negative functional layer, the negative functional layer having generally flake-shaped polyethylene particles; wherein the negative active material layer includes a negative active material including a crystalline carbonaceous material having a ratio I(002)/I(110) of an X-ray diffraction peak intensity at a (002) plane to an X-ray diffraction peak intensity at a (110) plane of the crystalline carbonaceous material ranging from about 30:1 to about 110:1.

### CROSS-REFERENCE TO RELATED APPLICATION

This application claims priority from and the benefit of Korean Patent Application No. 10-2019-0052569 filed on May 3, 2019, which is hereby incorporated by reference for all purposes as if fully set forth herein.

### BACKGROUND

### Field

Exemplary implementations of the invention relate generally to a negative electrode for a rechargeable lithium battery, and more specifically, to a rechargeable lithium battery having the same.

### Discussion of the Background

A rechargeable lithium battery having high energy density and easy portability has been generally used as a driving power source for a portable information device such as a cell phone, a laptop, a smart phone, and the like. Furthermore, studies for using the rechargeable lithium battery utilizing high energy density characteristics as a driving power source or power storage source have been actively researched.

Recently, mobile information devices have been rapidly down-sized and lightened, and thus the rechargeable lithium battery used as its driving power source has been required to have higher capacity and also to be cordlessly charged with a short charge time. Particularly, the shortened charge time, i.e., rapid charge, is in much demand as a long charge time is a great inconvenience to users.

However, a battery capable of rapid charging requires high input and output, and thereby has shortcomings related to thermal and physical safety. For example, heat generation of the rechargeable lithium battery due to an internal short circuit, overcharge and over discharge, and the like, causes electrolyte decomposition and a thermal runaway phenomenon, thereby abruptly increasing internal pressure inside the battery that can produce an explosion. Particularly, when the internal short circuit of the rechargeable lithium battery occurs, there is a high risk of explosion, as high electrical energy stored in the shorted positive electrode and negative electrode suddenly conducts.

Such an explosion can cause fatal damage to users as well as destroy the rechargeable lithium battery, so there is much demand for improving the safety of the rechargeable lithium battery for if a rapid charge is required.

The above information disclosed in this Background section is only for understanding of the background of the inventive concepts, and, therefore, it may contain information that does not constitute prior art.

### SUMMARY

Negative electrodes and rechargeable lithium batteries including the same constructed according to the principles and exemplary implementations of the invention exhibit good, high-rate charge characteristics and improved safety, e.g., with respect to thermal and physical impact.

Additional features of the inventive concepts will be set forth in the description which follows, and in part will be apparent from the description, or may be learned by practice of the inventive concepts.

According to one aspect of the invention, a negative electrode for a rechargeable lithium battery, includes: a sequential laminate having a negative current collector, a negative active material layer, and a negative functional layer, the negative functional layer having generally flake-shaped polyethylene particles; wherein the negative active material layer includes a negative active material including a crystalline carbonaceous material having a ratio I₍₀₀₂₎/I₍₁₁₀₎ of an X-ray diffraction peak intensity at a (002) plane to an X-ray diffraction peak intensity at a (110) plane of the crystalline carbonaceous material ranging from about 30:1 to about 110:1.

The crystalline carbonaceous material may include artificial graphite, a natural graphite, or a combination thereof.

The ratio I₍₀₀₂₎/I₍₁₁₀₎ of the X-ray diffraction peak intensity at a (002) plane to the X-ray diffraction peak intensity at a (110) plane of the crystalline carbonaceous material may be about 35:1 to about 105:1.

At least some of the generally flake-shaped polyethylene particles may have a particle size of about 1 μm to about 8 μm.

At least some of the generally flake-shaped polyethylene particles may have a ratio of a length of a long axis to a length of a short axis of about 1:1 to about 5:1.

At least some of the generally flake-shaped polyethylene particles may have a thickness of about 0.2 μm to about 4 μm.

The negative functional layer may further include an inorganic particle and a binder.

The amount of the generally flake-shaped polyethylene particles and the inorganic particles may be about 80 wt % to about 99 wt % based on a total weight of the negative functional layer.

The generally flake-shaped polyethylene particles and the inorganic particles may be included at a weight ratio of about 95:5 to about 10:90.

The negative functional layer may have a thickness of about 1 μm to about 10 μm.

A rechargeable lithium battery, may include: a positive electrode having a positive current collector and a positive active material layer at least partially disposed on the positive current collector; the negative electrode as described above; and an electrolyte.

The positive active material layer may include a first positive active material having at least one of a composite oxide of lithium and a metal of cobalt, manganese, nickel, or a combination thereof; and a second positive active material having a compound of Formula 1:

LiₐFe₁₋ₓMₓPO₄; wherein, 0.90≤a≤1.8, 0≤x≤0.7, M is Mn, Co, Ni or combination Chemical Formula 1 thereof.

The first positive active material may be at least one of LiCoO₂; Li_{b}M¹_{1-yl-zl}M²_{yl}M³_{zl}O₂ (wherein 0.9≤b≤1.8, 0≤yl≤1, 0≤zl≤1, 0≤yl+zl≤1, and M¹, M², and M³ may be each, independently from one another, a metal of Ni, Co, Mn, Al, Sr, Mg, La, or a combination thereof); or a combination thereof.

The second positive active material may include LiFePO₄.

The positive electrode further may include a positive functional layer at least partially disposed on the positive active material layer.

The first positive active material may be disposed in the positive active material layer, and the second positive active material may be disposed in at least one of the positive active material layer and the positive functional layer.

The weight ratio of the first positive active material and the second positive active material may be about 97:3 to about 80:20.

The amount of the first positive active material may be about 70 wt % to about 99 wt % based on the total weight of the positive active material layer, and an amount of the second positive active material may be about 1 wt % to about 30 wt % based on the total weight of the positive active material layer.

According to one aspect of the invention, a rechargeable lithium battery, includes: a negative electrode including a negative current collector, a negative active material layer, and a negative functional layer including generally flake-shaped polyethylene particles; wherein the negative active material layer includes a negative active material including a crystalline carbonaceous material having a ratio I₍₀₀₂₎/I₍₁₁₀₎ of an X-ray diffraction peak intensity at a (002) plane to an X-ray diffraction peak intensity at a (110) plane of the crystalline carbonaceous material ranging from about 30:1 to about 110:1; a positive electrode including a positive current collector and a positive active material layer at least partially disposed on the positive current collector, and a positive functional layer at least partially disposed on the positive active material layer; and an electrolyte.

The positive active material layer may be entirely disposed on the positive current collector, and a positive functional layer may be entirely disposed on the positive active material layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view of an exemplary embodiment of a rechargeable lithium battery constructed according to principles of the invention.

FIG. 2A is a schematic diagram of an exemplary embodiment of the negative electrode for the rechargeable lithium battery constructed according to principles of the invention.

FIG. 2B is a schematic diagram of an exemplary embodiment of the positive electrode for the rechargeable lithium battery constructed according to principles of the invention.

FIG. 3 is scanning electron microscope (SEM) photograph of an exemplary embodiment of polyethylene generally spherical-shaped particles in a state of a distributed solution.

FIG. 4 is a SEM photograph of an exemplary embodiment of generally flake-shaped polyethylene particles according to Example 1-1.

FIG. 5 is a graphical depiction illustrating high-temperature capacity characteristics and thickness variation of an exemplary embodiment of a rechargeable lithium cell according to Example 1-1 and a comparative embodiment of a rechargeable lithium cell according to Comparative Example 4.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Alternatively, the descriptions of the well-known functions or constructions in the following discussion may be omitted. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, film, region, or plate, is referred to as being “on,” “connected to,” or “coupled to” another element, layer, film, region, or plate, it may be directly on, connected to, or coupled to the other element, layer, film, region, or plate, or intervening elements, layers, films, regions, or plates may be present. When, however, an element, layer, film, region, or plate is referred to as being “directly on,” “directly connected to,” or “directly coupled to” another element, layer, film, region, or plate, there are no intervening elements, layers, films, regions, or plates present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z—axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As used herein, “weight percent” may be abbreviated herein as “wt %”.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

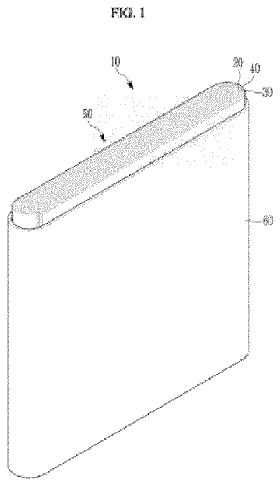

FIG. 1 is a perspective view of an exemplary embodiment of a rechargeable lithium battery constructed according to principles of the invention.

A rechargeable lithium battery 10 according to some exemplary embodiments is a prismatic battery, but is not limited thereto, and may include variously-shaped batteries such as a generally shaped cylindrical battery, pouch-type battery, and the like.

Referring to FIG. 1, the rechargeable lithium battery 10 according to some exemplary embodiments includes a wound electrode assembly 50 including a negative electrode 20, a positive electrode 30, and a separator 40 disposed therebetween, and a case 60 housing the electrode assembly 50. The negative electrode 20, positive electrode 30, and the separator 40 may be impregnated in an electrolyte solution.

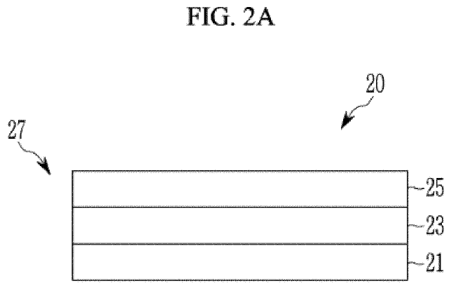

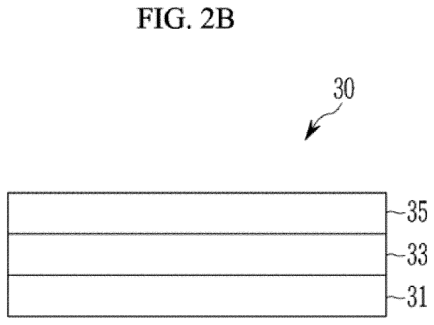

FIG. 2A is a schematic diagram of an exemplary embodiment of the negative electrode for the rechargeable lithium battery constructed according to principles of the invention.

Referring to FIG. 2A, the negative electrode 20 for the rechargeable lithium battery includes a negative current collector 21, a negative active material layer 23 positioned on the negative current collector 21, and a negative functional layer 25 positioned on the negative active material layer 23, which may form a sequential laminate 27.

The negative current collector 21 may include a copper foil, a nickel foil, a stainless steel foil, a titanium foil, a nickel foam, a copper foam, a polymer substrate coated with a conductive metal, or a combination thereof.

The negative active material layer 23 includes a negative active material including a crystalline carbonaceous material. The crystalline carbonaceous material may be an artificial graphite, a natural graphite, or a combination thereof, and in some exemplary embodiments, artificial graphite alone. The artificial graphite may be a coke type of artificial graphite such as a needle-coke, an isotopic coke, a sponge coke, or a shot coke. When the artificial graphite having such a structure is used, an orientation of the negative active material may be suitably increased and the rapid charge characteristics of the battery may be improved.

The coke type of artificial graphite may be obtained by graphitization heat-treating each of the needle-coke, isotopic coke, or shot coke. The negative active material may further include a Si-based material, a Sn-based material, or a combination thereof.

The Si-based material or the Sn-based material may be Si, a Si—C composite, SiOₓ (0<x≤2), a Si-Q alloy (wherein Q is an element selected from an alkali metal, an alkaline-earth metal, a Group 13 element, a Group 14 element, a Group 15 element, a Group 16 element, a transition metal, a rare earth element, or a combination thereof, and is not Si), Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, or a combination thereof, and is not Sn), and the like, and at least one of these materials may be mixed with SiO₂. The elements Q and R may be selected, independently from one another, from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The Si-based material, the Sn-based material, or a combination thereof may be included in an amount of about 0.1 wt % to about 20 wt % based on the total weight of the negative active material. When the amount of the Si-based material or the Sn-based material is within this range, expansion of the electrode may be suppressed and the cycle-life characteristics and the charge and discharge efficiency of the battery may be improved.

A ratio I₍₀₀₂₎/I₍₁₁₀₎ of an X-ray diffraction peak intensity at a (002) plane to an X-ray diffraction peak intensity at a (110) plane of the crystalline carbonaceous material may be about 30:1 or more, for example, about 35:1 or more, or about 40:1 or more, and about 110:1 or less, about 105:1 or less, or about 100:1 or less.

Generally, as a ratio I₍₀₀₂₎/I₍₁₁₀₎ of the X-ray diffraction peak intensity at a (002) plane to the X-ray diffraction peak intensity at a (110) plane is reduced, random-orientation is increased to increase the degree of disorder of the orientation of the crystalline carbonaceous material. Thus, the intercalation and deintercalation of the lithium ions into/from the negative active material during charging and discharging can easily occur, and this material may be suitably applied for rapid charging. However, the extremely high random orientation causes a decrease in a pellet density of the negative active material, thereby reducing the specific capacity of the battery and causes very high input and output to occur, thereby reducing the safety of the battery. Thus, when the ratio I₍₀₀₂₎/I₍₁₁₀₎ is within the above range, the specific capacity of the battery 10 may be suitably maintained and the improved high rate charge characteristics may be exhibited.

The ratio I₍₀₀₂₎/I₍₁₁₀₎ (hereinafter, referred as X-ray diffraction peak intensity ratio I₍₀₀₂₎/I₍₁₁₀₎) of the crystalline carbonaceous material may be increased by, for example, increasing the heat-treatment temperature or adding a SiC graphitization catalyst in the preparation of the crystalline carbonaceous material. The X-ray pattern may be determined by using copper Kα radiation, when a specific limitation is not otherwise provided, and the peak intensity refers to a height ratio each of the peaks.

The negative active material may be included in an amount of about 95 wt % to about 98.5 wt, for example, about 95 wt % to about 98 wt %, based on the total weight of the negative active material layer 23.

In some exemplary embodiments, the negative active material layer 23 may optionally further include a negative binder and a negative conductive material. The negative binder acts to adhere negative active material particles to each other and to adhere negative active materials to the negative current collector 21. The negative binder may be a non-aqueous binder, an aqueous binder, or a combination thereof. The non-aqueous binder may be a polyvinyl chloride, a carboxylated polyvinyl chloride, a polyvinylfluoride, an ethylene oxide-containing polymer, a polyvinylpyrrolidone, a polyurethane, a polytetrafluoroethylene, a polyvinylidene fluoride, a polyethylene, a polypropylene, a polyamideimide, a polyimide, or a combination thereof.

The aqueous binder may be a rubber-based binder or a polymer resin binder. The rubber-based binder may be a styrene-butadiene rubber, an acrylated styrene-butadiene rubber (SBR), an acrylonitrile butadiene rubber, an acryl rubber, a butyl rubber, a fluorine rubber, or a combination thereof. The polymer resin binder may be a polypropylene, an ethylene propylene copolymer, a polyepichlorohydrin, a polyphosphazene, a polyacrylonitrile, a polystyrene, an ethylene propylene diene copolymer, a polyvinylpyrridine, a chlorosulfonated polyethylene, a latex, a polyester resin, an acryl resin, a phenol resin, an epoxy resin, a polyvinyl alcohol, or a combination thereof.

When the aqueous binder is used as a negative electrode binder, a cellulose-based compound may be further used to provide viscosity as a thickener. The cellulose-based compound includes one or more of a carboxymethyl cellulose, a hydroxypropylmethyl cellulose, a methyl cellulose, or an alkali metal salt thereof. The alkali metal may be Na, K, or Li. The thickener may be included in an amount of about 0.1 wt % to about 3 wt % based on a total weight of the negative active material.

When the negative active material layer 23 further includes the negative binder, the negative binder may be included in an amount of about 1 wt % to about 5 wt % based on the total weight of the negative active material layer 23 and the negative active material may be included in an amount of about 95 wt % to 99 wt % based on the total weight of the negative active material layer 23.

The conductive material is included to provide electrode conductivity. Any electrically conductive material may be used as a conductive material unless it causes a chemical change. Examples of the conductive material include a carbon-based material such as a natural graphite, an artificial graphite, a carbon black, an acetylene black, a carbon black sold under the trade designation KETJENBLACK, a carbon fiber, and the like; a metal-based material of a metal powder or a metal fiber including copper, nickel, aluminum, silver, and the like; a conductive polymer such as a polyphenylene derivative; or a mixture thereof.

When the negative active material layer 23 includes the negative binder and the negative conductive material, the negative conductive material may be included in an amount of about 1 wt % to about 5 wt % based on the total weight of the negative active material layer 23, the negative binder may be included in an amount of about 1 wt % to about 5 wt % based on the total weight of the negative active material layer 23 and the negative active material may be included in an amount of about 90 wt % to about 98 wt % based on the total weight of the negative active material layer 23. The thickness of the negative active material layer 23 may be about 30 μm to about 90 for example about 40 μm to about 80 or about 50 μm to about 70 μm.

According to some exemplary embodiments, the negative functional layer 25 may include a generally flake-shaped polyethylene particle. A battery with rapid charge and discharge characteristics may have shortcomings related to thermal and physical safety due to high input and output, but the negative functional layer 25 coated on the negative active material layer 23 may quickly shut down the battery under the abnormal operation or the runaway heat of the battery, thereby improving the thermal and physical safety of the battery 10.

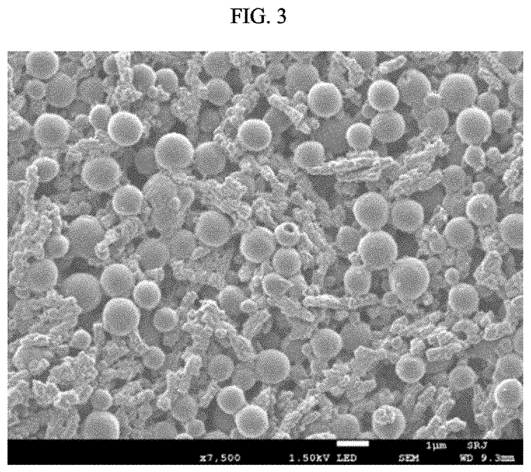

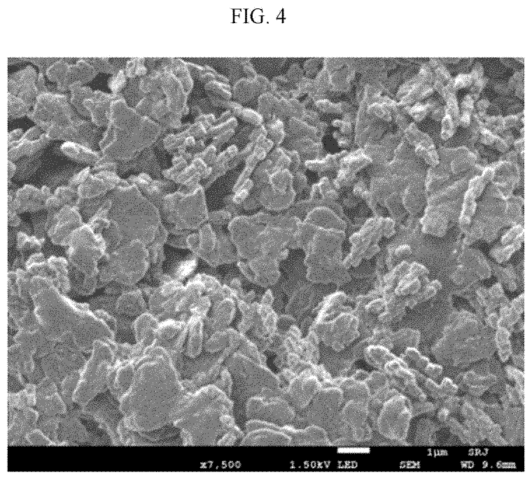

FIG. 3 is scanning electron microscope (SEM) photograph of an exemplary embodiment of polyethylene generally spherical-shaped particles in a state of a distributed solution. FIG. 4 is a SEM photograph of an exemplary embodiment of generally flake-shaped polyethylene particles according to Example 1-1.

The shapes of the generally spherical and flake-shaped polyethylene particles are illustrated in FIG. 3 and FIG. 4. Referring to FIG. 3 and FIG. 4, it can be seen that the generally flake-shaped polyethylene particle may have a clearly different shape from the generally spherical-shaped polyethylene particle. Thus, the generally flake-shaped polyethylene particle according to some exemplary embodiments may provide a thinner and wider functional layer, i.e., a greater surface area, compared to the generally spherical particle, and may be quickly melted to close a wide area of an ion path.

Generally, polyethylene may be classified into HDPE (high density polyethylene, density: 0.94 g/cc to 0.965 g/cc), MDPE (medium density polyethylene, density: 0.925 g/cc to 0.94 g/cc), LDPE (low density polyethylene, density: 0.91 g/cc to 0.925 g/cc), and VLDPE (very low density polyethylene, density: 0.85 g/cc to 0.91 g/cc), depending on the density.

The generally flake-shaped polyethylene particle may be used alone or as a mixture of two or more polyethylene polymers, for example, HDPE, MDPE, and LDPE. The generally flake-shaped polyethylene particle may have a melting point (Tm) of about 80° C. to about 150° C., for example, about 90° C. to about 140° C. determinable by differential scanning calorimetry (DSC) according to ISO 11357-3. The density of the generally flake-shaped polyethylene particle may be about 0.91 g/cc to about 0.98 g/cc, and specifically, about 0.93 g/cc to about 0.97 g/cc. The particle size of the generally flake-shaped polyethylene particle may be about 1 μm to about 8 μm, for example, about 1.5 μm or more, about 2.0 μm or more, or about 2.5 μm or more, and about 8 μm or less, about 7.5 μm or less, about 7 μm or less, about 6.5 μm or less, about 6.0 μm or less, about 5.5 μm or less, about 5 μm or less, about 4.5 μm or less, about 4 μm or less, about 3.5 μm or less, or about 3 μm or less.

The ratio of a length of the long axis to a length of the short axis of the generally flake-shaped polyethylene particle may be about 1:1 to about 5:1, specifically, about 1.1:1 to about 4.5:1, and for example about 1.2:1 to about 3.5:1. Specifically, the ratio may refer to the aspect ratio of the minimum to the maximum Feret diameter. The Aspect Ratio ψ_{A}(0<ψ_{A}≤1) is defined by the ratio of the Minimum to the Maximum Feret Diameter ψA=x_{Feret min}/x_{Feret max}. It gives an indication for the elongation of the particle. Furthermore, the thickness of the generally flake-shaped polyethylene particle may be about 0.2 μm to about 4 μm, and specifically, about 0.3 μm to about 2.5 μm, about 0.3 μm to about 1.5 μm, or about 0.3 μm to about 1 μm.

When the size of the generally flake-shaped polyethylene particle, the ratio of the length of the long axis to the length of the short axis, and the thickness are within the above ranges, resistance to transferring lithium ions is minimized to secure the performance of the battery 10, and the shut-down function is further improved to initially prevent the heat generation of the battery 10.

The size of the generally flake-shaped polyethylene particle may be an average particle size (D₅₀) which refers to 50% by volume in the cumulative size-distribution curve. The average particle size D₅₀ may be determined by general methods which are well known to one of ordinary skill in the art, for example, using a particle size analyzer, or using transmission electron microscope photography or scanning electron microscope photography. Alternatively, the D₅₀ may be obtained by measuring with a measurement device using dynamic light-scattering, and analyzing the resulting data to count numbers of particles of each particle size and determine the result therefrom.

More precisely, the particle size of a flake-shaped polyethylene particle may be determined by a dynamic light-scattering measurement method. Specifically, the size may be measured by ISO 13320 through the analysis of the light-scattering properties of the particles. Alternatively, the sizes may be determined by using a laser scattering particle size analyzer, e.g., sold under the trade designation LS13 320 series available from Beckman Coulter Inc., of Brea, Calif. Before measuring the sizes, the positive active material may be pre-treated by adding the positive active material to a main solvent at a predetermined amount, e.g., 5 wt % to dilute and ultrasonically disperse them for a predetermined time, e.g., 1 minute. For the non-spherical particles, a size distribution is reported, where the predicted scattering pattern for the volumetric sum of spherical particles matches the measured scattering pattern.

The negative functional layer 25 may optionally further include an inorganic particle and a binder, together with the generally flake-shaped polyethylene particle. If they are further included, the heat generation of the battery 10 initiating the shut-down function of the generally flake-shaped polyethylene particle may be initially prevented and the electrical insulation of the inorganic particle may prevent the short-circuit between the positive and the negative electrodes, and the binder acts to bind the generally flake-shaped polyethylene particle and the inorganic particle and adhere them to the negative active material layer 23. Thus, the thermal and physical safety and the cycle-life characteristics of the rechargeable lithium battery 10 may be improved.

The inorganic particle may be, for example, Al₂O₃, SiO₂, TiO₂, SnO₂, CeO₂, MgO, NiO, CaO, GaO, ZnO, ZrO₂, Y₂O₃, SrTiO₃, BaTiO₃, Mg (OH)₂, a boehmite, or a combination thereof, but is not limited thereto. Furthermore, in addition to the inorganic particle, the organic particles may include an acryl compound, an imide compound, an amide compound, or a combination thereof, but is not limited thereto.

The inorganic particle may have a generally spherical, flake, cubic, granular, or unspecified shape. The average particle size D₅₀ of the inorganic particle may be about 1 nm to about 2,500 nm, for example, about 100 nm to about 2,000 nm, about 200 nm to about 1,000 nm, or about 300 nm to about 800 nm. The particle size may be determined by a dynamic light-scattering measurement method, for example ISO 13320. Alternatively, the sizes may be determined by using a laser scattering particle size analyzer, e.g., sold under the trade designation LS13 320 series available from Beckman Coulter Inc., of Brea, Calif. Before measuring the sizes, the positive active material may be pre-treated by adding the positive active material to a main solvent at a predetermined amount, e.g., 5 wt % to dilute and ultrasonically disperse them for a predetermined time, e.g., 1 minute.

The sum amount of the generally flake-shaped polyethylene particle and the inorganic particle may be about 80 wt % to about 99 wt %, and specifically, about 85 wt % to about 97 wt %, about 90 wt % to about 97 wt %, about 93 wt % to about 97 wt %, or about 95 wt % to about 97 wt % based on the total weight of the negative functional layer 25.

The weight ratio of the generally flake-shaped polyethylene particle and the inorganic particle may be about 95:5 to about 10:90, and specifically, about 75:25 to about 30:70, about 70:30 to about 35:65, about 65:35 to about 40:60, about 60:40 to about 45:55, or about 55:45 to about 50:50. As such, the thickness of the negative functional layer 25 may be suitably controlled and the safety of the battery 10 may be simultaneously and effectively improved.

The binder may be the same as one which is used in the negative active material layer 23, but it is not limited thereto, although it may be generally used in the rechargeable lithium battery 10. The amount of the binder may be about 1 wt % to about 20 wt %, and specifically, about 3 wt % to about 15 wt %, about 3 wt % to about 10 wt %, about 3 wt % to about 7 wt %, or about 3 wt % to about 5 wt % based on the total weight of the negative functional layer 25. The thickness of the negative functional layer 25 may be about 1 μm to about 10 μm, specifically, about 2 μm to about 8 μm and preferably about 3 μm to about 7 μm.

FIG. 2B is a schematic diagram of an exemplary embodiment of the positive electrode for the rechargeable lithium battery constructed according to principles of the invention.

Referring to FIG. 2B, another exemplary embodiment provides the rechargeable lithium battery 10 including a positive electrode 30 having a positive current collector 31 and a positive active material layer 33, including a positive active material, positioned on the positive current collector 31. The battery 10 may also include the negative electrode 20 and an electrolyte. The negative electrode 20 may be the same as discussed above according to some exemplary embodiments. The positive current collector 31 may be a copper foil, a nickel foil, a stainless steel foil, a titanium foil, a nickel foam, a copper foam, a polymer substrate coated with a conductive metal, or a combination thereof.

The positive active material layer 33 includes a first positive active material including at least one of a composite oxide of a metal selected from cobalt, manganese, nickel, or a combination thereof, and lithium; and a second positive active material including a compound represented by Chemical Formula 1.

LiₐFe₁₋ₓMₓPO₄; Chemical Formula 1

wherein, 0.90≤a≤1.8, 0≤x≤0.7, and M is Mn, Co, Ni, or a combination thereof.

The first positive active material may specifically be LiCoO₂; Li_{b}M¹_{1-yl-zl}M²_{yl}, M³_{zl}O₂₁ (0.9≤b≤1.8, 0≤yl≤1, 0≤zl≤1, 0≤yl+zl≤1, M¹, M², and M³ are each independently a metal selected from Ni, Co, Mn, Al, Sr, Mg, La, etc.); or a combination thereof.

For example, the first positive active material may be LiCoO₂, but is not limited thereto. For example, the M¹ may be Ni, and the M² and M³ are each independently a metal selected from Co, Mn, Al, Sr, Mg, La, etc. Specifically, the M¹ may be Ni, the M² may be Co, and the M³ may be Mn or Al, but are not limited thereto. The second positive active material may include, for example, LiFePO₄.

The average diameter of the first positive active material may be about 10 μm to about 30 μm, specifically, about 10 μm to about 25 μm, and for example about 13 μm to about 20 μm. Furthermore, the average diameter of the second positive active material may be about 300 nm to about 700 nm, specifically about 300 nm to about 600 nm, and for example about 300 nm to about 500 nm. When the average diameters of the first positive active material and the second positive active material are within the ranges, energy density may be increased, so that the high-capacity rechargeable lithium battery 10 may be realized. The sizes may be determined by a dynamic light-scattering measurement method, for example ISO 13320. Alternatively, the sizes may be determined by using a laser scattering particle size analyzer, e.g. sold under the trade designation LS13 320 series available from Beckman Coulter Inc., of Brea, Calif. Before measuring the sizes, the positive active material may be pre-treated by adding the positive active material to a main solvent at a predetermined amount, e.g., 5 wt %, to dilute and ultrasonically disperse them for a predetermined time, e.g., 1 minute.

The rechargeable lithium battery 10 according to some exemplary embodiments includes the negative functional layer 25 positioned on the negative active material layer 23 as well as the positive active material layer 33 including the first positive active material and the second positive active material, so that the speed for increasing heat due to the thermal/physical impact may be decreased, and it is helpful to completely close a path for moving ions by melting the generally flake-shaped polyethylene particle.

According to some exemplary embodiments, a positive functional layer 35 may be positioned on the positive active material layer 33. The first positive active material may be included in the positive active material layer 33, and the second positive active material may be included in at least one of the positive active material layer 33 and the positive functional layer 35. In some exemplary embodiments, the weight ratio of the first positive active material and the second positive active material may be about 97:3 to about 80:20, and for example, about 95:5 to about 85:15.

An amount of the first positive active material may be about 70 wt % to about 99 wt %, and specifically, about 85 wt % to about 99 wt %, about 85 wt % to about 95 wt %, or about 85 wt % to about 93 wt % based on the total weight of the positive active material layer 33. When the amount of the first positive active material is satisfied in the range, the safety of the battery 10 may be improved, without a decrease of the capacity.

Furthermore, the amount of the second positive active material may be about 1 wt % to about 30 wt %, and specifically, about 1 wt % to about 15 wt %, about 5 wt % to about 15 wt %, or about 7 wt % to about 15 wt % based on the total weight of the positive active material layer 33. When the amount of the second positive active material is satisfied in the range, the safety of the battery 10 may be improved, without a decrease of the capacity.

The positive active material layer 33 may optionally further include a positive conductive material and a positive binder. The positive conductive material is included to provide electrode conductivity and the positive conductive materials may be the same as the above negative conductive materials.

The positive binder improves binding properties of positive active material particles with one another and with the positive current collector 31. Examples thereof may be a polyvinyl alcohol, a carboxymethyl cellulose, a hydroxypropyl cellulose, a diacetyl cellulose, a polyvinylchloride, a carboxylated polyvinylchloride, a polyvinylfluoride, an ethylene oxide-containing polymer, a polyvinylpyrrolidone, a polyurethane, a polytetrafluoroethylene, a polyvinylidene fluoride, a polyethylene, a polypropylene, a styrene butadiene rubber, an acrylated styrene butadiene rubber, an epoxy resin, a nylon, and the like, but are not limited thereto.

When the positive active material layer 33 includes the positive conductive material, the positive conductive material may be included in an amount of about 1 wt % to about 5 wt % based on the total amount of the positive active material layer 33.

When the positive active material layer 33 includes the positive binder, the positive binder may be included in an amount of about 1 wt % to about 5 wt % based on the total amount of the positive active material layer 33.

The positive electrode 30 may further include the positive functional layer 35 positioned on the positive active material layer 33, as discussed above. Furthermore, the first positive active material may be included in the positive active material layer 33, and the second positive active material may be included in at least one of the positive active material layer 33 and the positive functional layer 35. As such, the safety due to the thermal and physical impact may be further improved. The positive functional layer 35 includes the second positive active material, and may further optionally include the positive conductive material and the positive binder.

The second positive active material included in the positive functional layer 35 may be included in an amount of about 95 wt % to about 99 wt %, and more specifically, about 96 wt % to about 99 wt %, about 97 wt % to about 99 wt %, or about 98 wt % to about 99 wt % based on the total weight of the positive functional layer 35.

If the positive functional layer 35 includes the positive conductive material, the positive conductive material may be included in an amount of about 1 wt % to about 5 wt % based on the total weight of the positive functional layer 35. If the positive functional layer 35 includes the positive binder, the positive binder may be included in an amount of about 1 wt % to about 5 wt % based on the total weight of the positive functional layer 35.

The electrolyte according to some exemplary embodiments includes a non-aqueous organic solvent and a lithium salt. The non-aqueous organic solvent serves as a medium for transmitting ions taking part in the electrochemical reaction of the battery 10. The non-aqueous organic solvent may include a carbonate-based, an ester-based, an ether-based, a ketone-based, an alcohol-based, or an aprotic solvent. The carbonate based solvent may include a dimethyl carbonate (DMC), a diethyl carbonate (DEC), a dipropyl carbonate (DPC), a methylpropyl carbonate (MPC), an ethylpropyl carbonate (EPC), a methylethyl carbonate (MEC), an ethylene carbonate (EC), a propylene carbonate (PC), a butylene carbonate (BC), and the like. The ester-based solvent may include a methyl acetate, an ethyl acetate, an n-propyl acetate, a t-butyl acetate, a methyl propionate, an ethyl propionate, a γ-butyrolactone, a decanolide, a valerolactone, a mevalonolactone, a caprolactone, and the like. The ether-based solvent may include a dibutyl ether, a tetraglyme, a diglyme, a dimethoxyethane, a 2-methyltetrahydrofuran, a tetrahydrofuran, and the like. The ketone-based solvent includes a cyclohexanone and the like. The alcohol-based solvent include an ethyl alcohol, an isopropyl alcohol, and the like, and examples of the aprotic solvent include one or more nitriles such as R—CN (where R is a C2 to C20 linear, branched, or cyclic hydrocarbon, and may include a double bond, an aromatic ring, or an ether bond), amides such as a dimethylformamide, one or more dioxolanes such as 1,3-dioxolane, one or more sulfolanes, and the like.

The organic solvent may be used alone or in a mixture. When the organic solvent is used in a mixture, the mixture ratio may be controlled in accordance with a desirable battery performance.

The carbonate-based solvent may include a mixture with a cyclic carbonate and a linear carbonate. The cyclic carbonate and linear carbonate are mixed together in a volume ratio of about 1:1 to about 1:9. When the mixture is used as an electrolyte, it may have enhanced performance.

The organic solvent may further include an aromatic hydrocarbon-based solvent as well as the carbonate-based solvent. The carbonate-based solvent and aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 2.

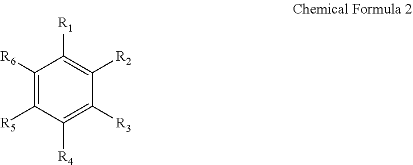

In Chemical Formula 2, R1 to R6 are the same or different and are selected from hydrogen, a halogen, a C1 to C10 alkyl group, a haloalkyl group, or a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The lithium salt dissolved in an organic solvent supplies a battery with lithium ions, basically operates the rechargeable lithium battery, and improves transportation of the lithium ions between positive and negative electrodes. Examples of the lithium salt include at least one supporting salt selected from LiPF6, LiBF4, LiSbF6, LiAsF6, LiN(SO2C2F5)2, Li(CF3SO2)2N, LiN(SO3C2F5)2, Li(FSO2)2N(lithium bis(fluorosulfonyl)imide: LiF SI), LiC4F9SO3, LiClO4, LiAlO2, LiAlCl4, LiN(CxF2x+1SO2)(CyF2y+1SO2) (where x and y are, independently, natural numbers, for example an integer of 1 to 20), LiCl, LiI, and LiB(C2O4)2 (lithium bis(oxalato) borate; LiBOB).

A concentration of the lithium salt may range from about 0.1 M to about 2.0 M in the organic solvent. When the lithium salt is included at the above concentration range, an electrolyte may have excellent performance and lithium ion mobility due to optimal electrolyte conductivity and viscosity.

The electrolyte may further include an additive of vinylene carbonate, or an ethylene carbonate-based compound represented by Chemical Formula 3 to improve a cycle life.

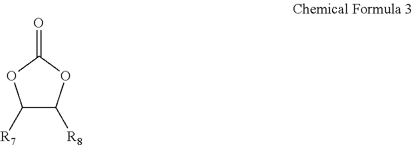

In Chemical Formula 3, R₇ and R₈ are the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.

Examples of the ethylene carbonate-based compound include difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving the cycle life may be flexibly used within an appropriate range.

The separator 40 may be disposed between the negative electrode 20 and the positive electrode 30. The separator 40 may be selected from, for example, a glass fiber, a polyester, a polyethylene, a polypropylene, a polytetrafluoroethylene, or a combination thereof, and may be a non-woven fabric or a woven fabric. For example, the rechargeable lithium battery 10 may mainly include a polyolefin-based polymer separator 40 such as at least one of a polyethylene and a polypropylene, and may include a separator 40 coated with a composition including a polymer material or a ceramic in order to secure heat-resistance or mechanical strength. Furthermore, the separator 40 may be used as a single layer or multi-layer structure.

### EXAMPLES

### Example 1-1

Preparation of Negative Electrode

Amounts of 98 wt % of the needle-coke type of artificial graphite, 0.8 wt % of carboxymethyl cellulose, and 1.2 wt % of styrene-butadiene rubber were mixed in pure water to prepare a negative active material slurry. The negative active material slurry was coated on both surfaces of the copper current collector, and dried and compressed to prepare a negative electrode on which a negative active material layer was formed. A X-ray diffraction peak intensity ratio I₍₀₀₂₎/I₍₁₁₀₎ of the artificial graphite was 100:1. The X-ray diffraction measurement was measured by the following conditions:

Voltage: 40 kV, 40 mA;

Wavelength: K-α1 wavelength 1.540598 Å, K-α2 wavelength 1.544426 Å;

10<2θ<90;

I(002) peak position: 20° to 30°; and

I(110) peak position: 70° to 80°.

Amounts of 48 wt % of the generally flake-shaped polyethylene(PE) particle (HDPE, density: 0.965 g/cc, average particle size D₅₀: 2 μm, ratio of the length of the long axis/length of the short axis: 2:1, thickness: 0.6 μm), 47 wt % of alumina (average particle diameter (D₅₀): 0.7 μm, granular shape), and 5 wt % of an acrylated styrene-based rubber binder were mixed in a 3-methoxy-3-methyl-1-butanol solvent to prepare a negative functional layer composition.

The negative functional layer composition was coated on both surfaces of the negative active material layer of the negative electrode, and dried and compressed to prepare a negative electrode on which a negative functional layer with a thickness of 5 μm, including the generally flake-shaped polyethylene (PE) particle was coated.

Fabrication of Rechargeable Lithium Battery

Amounts of 95 wt % of a positive active material in which LiCoO₂ (average diameter; 17 μm) and LiFePO₄ (average diameter; 0.4 μm) were mixed at a 9:1 weight ratio, 3 wt % of polyvinylidene fluoride, and 2 wt % of a KETJEN black conductive material were mixed in an N-methyl pyrrolidone solvent to prepare a positive active material slurry. The positive active material slurry was coated on both surfaces of an aluminum current collector, and dried and compressed to prepare a positive electrode in which a positive active material layer was formed.

The positive electrode, a separator of a multi layered polyethylene (PE)/polypropylene (PP), and the negative electrode in which the negative functional layer including the generally flake-shaped PE particle were sequentially laminated to prepare an electrode assembly, and an electrolyte was injected therein to fabricate a rechargeable lithium battery.

The electrolyte used was a solvent in which 1.0 M LiFP₆ was dissolved in the organic solvent (EC/DEC=50:50 volume ratio).

### Example 1-2

A rechargeable lithium battery was fabricated by the same procedure as in Example 1-1, except that a negative functional layer was prepared by using a generally flake-shaped PE particle (HDPE, density: 0.965 g/cc, average particle size: 4 μm, ratio of the length of long axis/length of short axis: 2.4:1, thickness: 0.6 μm) instead of using the generally flake-shaped polyethylene (PE) particle (average particle size: 2 μm, ratio of the length of long axis/length of short axis: 2:1, thickness: 0.6 um) of Example 1-1.

### Example 1-3

A rechargeable lithium battery was fabricated by the same procedure as in Example 1-1, except that a negative functional layer was prepared by using a generally flake-shaped PE particle (HDPE, density: 0.965 g/cc, average particle size: 6 μm, ratio of the length of long axis/length of short axis: 2.4:1, thickness: 0.6 μm) instead of using the generally flake-shaped polyethylene (PE) particle (average particle size: 2 μm, ratio of the length of long axis/length of short axis: 2:1, thickness: 0.6 μm) of Example 1-1.

### Example 2

A rechargeable lithium cell was fabricated by the same procedure as in Example 1-1, except that an artificial graphite having the X-ray diffraction peak intensity ratio I₍₀₀₂₎/I₍₁₁₀₎ of 40:1 was used instead of the artificial graphite of Example 1-1.

### Comparative Example 1

A rechargeable lithium cell was fabricated by the same procedure as in Example 1-1, except that an artificial graphite having the X-ray diffraction peak intensity ratio I₍₀₀₂₎/I₍₁₁₀₎ of 135:1 was used instead of the artificial graphite of Example 1-1.

### Comparative Example 2

A rechargeable lithium cell was fabricated by the same procedure as in Example 1-1, except that an artificial graphite having the X-ray diffraction peak intensity ratio I₍₀₀₂₎/I₍₁₁₀₎ of 20:1 was used instead of the artificial graphite of Example 1-1.

### Comparative Example 3

A rechargeable lithium battery was fabricated by the same procedure as in Example 1-1, except that a negative functional layer was prepared by using a spherical PE particle (LDPE, density: 0.925 g/cc, average particle size: 2 μm, ratio of the length of long axis/length of short axis: 1:1) instead of using the generally flake-shaped polyethylene (PE) article (HDPE, density: 0.965 g/cc, average particle size: 2 μ, ratio of the length of long axis/length of short axis: 2:1, thickness: 0.6 μm) of Example 1-1. A X-ray diffraction peak intensity ratio I₍₀₀₂₎/I₍₁₁₀₎ of the artificial graphite was 100:1.

### Comparative Example 4

A rechargeable lithium cell was fabricated by the same procedure as in Example 1-1, except that a negative functional layer was not included.

Evaluation 1: Evaluation of change of degree of orientation of negative electrode before/after forming negative functional layer

Regarding Example 1-1 to Example 1-3, Example 2, and Comparative Example 1 to Comparative Example 4, the X-ray diffraction peak intensities ratios, I₍₀₀₂₎/I₍₁₁₀₎ of artificial graphite before/after forming the negative functional layer were measured to compare them. As a result, significant changes were not found. Although the negative functional layer preparation included compress step after coating and drying, the solvent for preparing the negative functional layer allows releasing the stress of graphite during the compression, so it was expected that the peak intensity, I₍₀₀₂₎/I₍₁₁₀₎ of the negative active material was not changed before/after forming the negative functional layer. As a result, it can be seen that the characteristics of the degree of the orientation of the negative electrode (the X-ray diffraction peak intensity ratio I₍₀₀₂₎/I₍₁₁₀₎) were not dependent on the formation or no formation of the negative functional layer.

Evaluation 2: Evaluation of specific capacity characteristic of the half-cell and the rapid charge characteristics of the rechargeable lithium battery

Coin-type half-cells were fabricated by using a lithium metal counter electrode, instead of using the positive electrodes according to Example 1-1 to Example 1-3, Example 2, Comparative Example 1, Comparative Example 2, and Comparative Example 4. The fabricated coin-type half-cell was 0.2C, 0.01 V cut-off charged under the constant current condition, 0.05C cut-off charged under the constant voltage condition, and 0.2C, 1.5 V cut-off discharged under the constant current condition. Herein, the discharge capacity at the 1^{st} charge and discharge was measured and the specific capacity characteristics of the half-cells were evaluated. The results are shown in Table 1.

Rechargeable lithium cells according to Example 1-1 to Example 1-3, Example 2, Comparative Example 1, Comparative Example 2, and Comparative Example 4 were once charged and discharged in which 0.2C, 4.4 V cut-off charged under the constant current condition, 0.05C cut-off charged under the constant voltage condition, 2.75 V cut-off discharged under the constant current condition, and charged at 2.0 V, 4.4 V cut-off under the constant current condition and 0.05C cut-off under the constant voltage condition for 30 minutes. Thereafter, the cell was 0.2C, 3.0 V cut-off under the constant current condition. From the results, the ratio of the charge capacity at the 2^{nd} charge and discharge to the charge capacity at the 1^{st} charge and discharge was calculated to obtain a 30-minute rapid charge percentage (%). The results are shown in Table 1.

TABLE 1

| | Specific capacity | 30-minute rapid |
|---|---|---|
| | (discharge capacity at 0.2 C, | charge percentage |
| | 1^{st} charge | (2nd charge amount/ |
| | and discharge) (mAh/g) | 1st charge amount) (%) |
| Example 1-1 | 345 | 77.1 |
| Example 1-2 | 345 | 77.5 |
| Example 1-3 | 345 | 77.2 |
| Example 2 | 336 | 81.8 |
| Comparative | 351 | 65.1 |
| Example 1 | | |
| Comparative | 321 | 82.4 |
| Example 2 | | |
| Comparative | 345 | 77.2 |
| Example 4 | | |

Referring Table 1, as X-ray diffraction peak intensity ratio I₍₀₀₂₎/I₍₁₁₀₎ was decreased, the rapid charge characteristic was improved. However, in the half-cell according to Comparative Example 2, as the X-ray diffraction peak intensity ratio I₍₀₀₂₎/I₍₁₁₀₎ was extremely low, the degree of the random orientation was increased, the pellet density of the negative active material was reduced, and the specific capacity characteristic of the cell was deteriorated. That is, Example 1-1 to Example 1-3 and Example 2 include the negative active material having the X-ray diffraction peak intensity ratio I₍₀₀₂₎/I₍₁₁₀₎ within the range of the exemplary embodiments of the invention, so that the specific capacity was generally maintained, and the excellent rapid charge characteristics were simultaneously exhibited.

Evaluation 3: Measurement of high temperature cycle capacity characteristic and the change in thickness of rechargeable lithium battery.

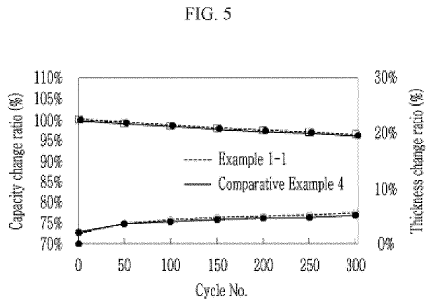

Regarding rechargeable lithium cells according to Example 1-1 and Comparative Example 4, the change in thickness and the cycle capacity characteristics at a high-temperature of 45° C. were measured. The charge and discharge was performed by charging at 2.0C, 4.4 V cut-off under the constant current, charging at 0.05C cut-off under the constant voltage, and discharging at 1.0C, 3.0 V cut-off under the constant current, which was regarded as one 1 cycle, and the repeated up to 300 cycles. The change in thickness was measured by using a vernier caliper under an SOC (State of Charge) 100% condition after charge and discharge. The results are shown in FIG. 5.

FIG. 5 is a graphical depiction illustrating high-temperature capacity characteristics and thickness variation of an exemplary embodiment of a rechargeable lithium cell according to Example 1-1 and a comparative embodiment of a rechargeable lithium cell according to Comparative Example 4.

From FIG. 5, it can be seen that the rechargeable lithium cell according to Example 1-1 exhibited similar high-temperature cycle capacity characteristics and the change in the thickness, compared to the rechargeable lithium cell according to Comparative Example 4. Thus, the high-temperature cycle capacity characteristics and the change in the thickness did not depend on the formation of the negative functional layer on the negative electrode according to some exemplary embodiments.

Evaluation 4: Evaluation of physical safety

Regarding rechargeable lithium cells according to Examples 1-1 to Example 1-3, Example 2, Comparative Example 3, and Comparative Example 4, penetration, fall, and collision tests were examined. The results for examining the physical safety are shown in Table 2. On the other hand, the physical safety evaluation criteria are as shown in Table 3.

TABLE 2

| | Penetration | Dropping | Collision |
|---|---|---|---|
| Example 1-1 | L2 | L2 | L2 |
| Example 1-2 | L2 | L2 | L2 |
| Example 1-3 | L2 | L2 | L2 |
| Example 2 | L2 | L2 | L2 |
| Comparative | L4 | L4 | L4 |
| Example 3 | | | |
| Comparative | L5 | L4 | L5 |
| Example 4 | | | |

TABLE 3

| Criteria Level | Criterion |
|---|---|
| L0 | No occurrence |
| L1 | Leakage of electrolyte, external temperature <150° C. |
| L2 | External temperature <200° C. |
| L3 | Smoke, external temperature >200° C. |
| L4 | Flame |
| L5 | Explosion |

Referring to Tables 2 and 3, it was shown that in the case of the rechargeable lithium cells according to Example 1-1 to Example 1-3 and Example 2, the passage for ions was effectively closed when the heat runaway occurred by the physical impact, thereby initially showing the shut-down function early, and the cells according to Example 1-1 to Example 1-3 and Example 2 unexpectedly exhibited better physical safety.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A negative electrode for a rechargeable lithium battery, comprising:
a sequential laminate having a negative current collector, a negative active material layer, and a negative functional layer, the negative functional layer comprising generally flake-shaped polyethylene particles;
wherein the negative active material layer comprises a negative active material including a crystalline carbonaceous material having a ratio I₍₀₀₂₎/I₍₁₁₀₎ of an X-ray diffraction peak intensity at a (002) plane to an X-ray diffraction peak intensity at a (110) plane of the crystalline carbonaceous material ranging from about 30:1 to about 110:1.

2. The negative electrode of claim 1, wherein the crystalline carbonaceous material comprises an artificial graphite, a natural graphite, or a combination thereof.

3. The negative electrode of claim 1, wherein the ratio I₍₀₀₂₎/I₍₁₁₀₎ of the X-ray diffraction peak intensity at a (002) plane to the X-ray diffraction peak intensity at a (110) plane of the crystalline carbonaceous material is about 35:1 to about 105:1.

4. The negative electrode of claim 1, wherein at least some of the generally flake-shaped polyethylene particles have a particle size of about 1μm to about 8μm.

5. The negative electrode of claim 1, wherein at least some of the generally flake-shaped polyethylene particles have a ratio of a length of a long axis to a length of a short axis of about 1:1 to about 5:1.

6. The negative electrode of claim 1, wherein at least some of the generally flake-shaped polyethylene particles have a thickness of about 0.2 μm to about 4 μm.

7. The negative electrode of claim 1, wherein the negative functional layer further includes an inorganic particle and a binder.

8. The negative electrode of claim 7, wherein an amount of the generally flake-shaped polyethylene particles and the inorganic particles is about 80 wt % to about 99 wt % based on a total weight of the negative functional layer.

9. The negative electrode of claim 7, wherein the generally flake-shaped polyethylene particles and the inorganic particles are included at a weight ratio of about 95:5 to about 10:90.

10. The negative electrode of claim 1, wherein the negative functional layer has a thickness of about 1 μm to about 10 μm.

11. A rechargeable lithium battery, comprising:
a positive electrode comprising a positive current collector and a positive active material layer at least partially disposed on the positive current collector;
the negative electrode of claim 1; and
an electrolyte.

12. The rechargeable lithium battery of claim 11, wherein the positive active material layer includes a first positive active material comprising at least one of a composite oxide of lithium and a metal of cobalt, manganese, nickel, or a combination thereof; and a second positive active material comprising a compound of Formula 1:
LiₐFe₁₋ₓMₓPO₄ Chemical Formula 1
wherein, 0.90≤a≤1.8, 0≤x≤0.7, M is Mg, Co, Ni or combination thereof.

13. The rechargeable lithium battery of claim 12, wherein the first positive active material is at least one of LiCoO₂; Li_{b}M¹_{1-yl-zl}M²_{yl}M³_{zl}O₂ (wherein 0.9≤b≤1.8, 0≤yl≤1, 0<zl≤1, 0≤yl+zl≤1, and M¹, M², and M³ are each, independently from one another, a metal of Ni, Co, Mn, Al, Sr, Mg, La, or a combination thereof); or a combination thereof.

14. The rechargeable lithium battery of claim 12, wherein the second positive active material comprises LiFePO₄.

15. The rechargeable lithium battery of claim 12, wherein the positive electrode further comprises a positive functional layer at least partially disposed on the positive active material layer.

16. The rechargeable lithium battery of claim 15, wherein the first positive active material is disposed in the positive active material layer, and
the second positive active material is disposed in at least one of the positive active material layer and the positive functional layer.

17. The rechargeable lithium battery of claim 12, wherein a weight ratio of the first positive active material and the second positive active material is about 97:3 to about 80:20.

18. The rechargeable lithium battery of claim 12, wherein an amount of the first positive active material is about 70 wt % to about 99 wt % based on the total weight of the positive active material layer, and
an amount of the second positive active material is about 1 wt % to about 30 wt % based on the total weight of the positive active material layer.

19. A rechargeable lithium battery, comprising:
a negative electrode comprising a negative current collector, a negative active material layer, and a negative functional layer comprising generally flake-shaped polyethylene particles; wherein the negative active material layer comprises a negative active material including a crystalline carbonaceous material having a ratio I₍₀₀₂₎/I₍₁₁₀₎ of an X-ray diffraction peak intensity at a (002) plane to an X-ray diffraction peak intensity at a (110) plane of the crystalline carbonaceous material ranging from about 30:1 to about 110:1;
a positive electrode comprising a positive current collector and a positive active material layer at least partially disposed on the positive current collector, and a positive functional layer at least partially disposed on the positive active material layer; and
an electrolyte.

20. The rechargeable lithium battery of claim 19, wherein the positive active material layer is entirely disposed on the positive current collector, and a positive functional layer is entirely disposed on the positive active material layer.
